(19) United States
(12) Patent Application Publication
(10) Pub. No.: US 2019/0350190 A1
(43) Pub. Date: Nov. 21, 2019

(54) Bait Station With Internal Weight

(71) Applicant: J.T. Eaton & Company, Inc., Twinsburg, OH (US)

(72) Inventors: Jonathan Polenick, Broadview Heights, OH (US); Dale Baker, Cleveland, OH (US); James Rodriguez, Las Vegas, NV (US)

(21) Appl. No.: 15/981,437

(22) Filed: May 16, 2018

(51) Int. Cl. A01M 23/00

(52) U.S. Cl. CPC A01M 23/00; A01M 23/26; A01M 23/005

(57) ABSTRACT

A bait station for use with trapping rodents, including a housing, a ballast located within a base of the housing to inhibit movement of the bait station, at least one rodent trap retention area located above the ballast, and at least one rodent access to an interior of the housing though a side panel of the base at a height greater than that of the ballast. The bait station may include a removable tray disposed above the ballast that includes the rodent trap retention area to facilitate rodent removal and cleaning. Opposing first and second rodent access openings may be located on opposite side walls of the base to facilitate rodent entry from multiple directions.

### BACKGROUND OF THE INVENTION

### 1. Field of the Invention

The present invention relates to bait stations for use with a rodent trap and more particularly relates to a weighted bait station that includes a ballast weight located within the bait station which inhibits movement of the bait station.

### 2. Background

Traditional rodent bait stations are used to limit access to bait, such as rodenticide bait and/or loaded rodent traps. Limiting access to such rodent control devices can be beneficial in preventing unintended human contact with the bait and/or trap. For example, the use of a bait station may prevent a child from inadvertently obtaining harmful bait or coming into contact with a loaded trap. Similarly, the use of bait stations may protect those individuals that did not know of the traps location from inadvertently contacting the trap. Additionally, traditional bait traps are used to restrict animals that are larger than the target animal size from obtaining the rodenticide bait or otherwise contacting the loaded trap. Such use is often beneficial in maintaining the safety of household pets, such as dogs and cats.

Traditional bait stations are formed of light weight boxes of metal or plastics and often require external anchors to maintain their position. Typical anchors include screws and/or nails that fasten the bait station to the desired location. Such anchors may be undesirable as their installation and use may damage the floor or wall surfaces into which the anchors are placed. Accordingly, there is need for a bait station that does not require external fasteners to inhibit movement of the bait station, either by the target rodent or another.

There is also need for a bait station that is easily accessed and cleaned, to facilitate improved ease of rodent disposal and resetting of the bait station without undue hinderance.

### BRIEF DESCRIPTION OF THE INVENTION

By way of nonlimiting summary, in accordance with one aspect, the present invention addresses at least some of the above-referenced needs by providing a bait station that includes a ballast weight located within the base of a closed housing, in which a rodent enters the housing through an access opening located at a height above the ballast. Once inside the housing, a rodent engages a rodent trap disposed within the closed housing.

In one preferred embodiment, the bait station of the present invention is formed of a housing having a base and a cover that is rotatably affixed to the base. The base has a bottom defined within a perimeter and at least one side panel that extends upwardly from the bottom. The side panel has a height defined between a first edge that is congruent with the perimeter of the bottom of the base, and an opposing second edge. A ballast is positioned within the base and includes a top, a bottom and sides extending from the top to the bottom. At least one rodent trap retention area is located within the housing and above the top of the ballast. At least one rodent access opening to the interior of the housing is provided within the base.

In one preferred embodiment of the present invention, the bait station may include a latch having a lower latch frame extending from the base that is configured to engage an upper latch frame extending from the cover when the cover is in a closed configuration. A key may pass through an opening in the cover to engage the latch and release the upper latch frame from engagement with the lower latch frame.

In another embodiment, the bait station may also include a removable tray that is positioned on the top of the ballast within the base. In this embodiment, the rodent trap retention area may be located on a top of the tray.

In another embodiment, at least one rodent trap may be affixed to at least one rodent trap fastener at a rodent trap retention area of a tray.

In another embodiment, the bait station may have an outer surface that includes contours to simulate the appearance of a stone or other innocuous item when the cover is in a closed configuration.

In another embodiment, the bait station includes a first rodent access opening in a first side panel and a second access opening in an opposing second side panel.

In another embodiment, the distance from the rodent access opening to a rear of the base is less than a distance from the access opening to the front of the base.

These and other features and aspects of the present invention will be better appreciated and understood when considered in conjunction with the following description and the accompanying drawings. It should be understood, however, that the following description, while indicating representative embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an exploded front side perspective view of a bait station in accordance with one embodiment of the present invention;

FIG. 2 is a front side perspective view of the bait station of FIG. 1 shown with the top cover in the open position and a mechanical animal trap located at the rodent trap retention area of the removable tray;

FIG. 3 is an exploded rear side perspective view of the bait station of FIG. 1;

FIG. 4 is a cross sectional view of the bait station of FIG. 1 shown with the top cover in the closed position taken along line 4-4; and,

FIG. 5 is a cross sectional view of the bait station of FIG. 1 shown with the cover in the closed position taken along line 5-5

In describing the embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose.

### DETAILED DESCRIPTION

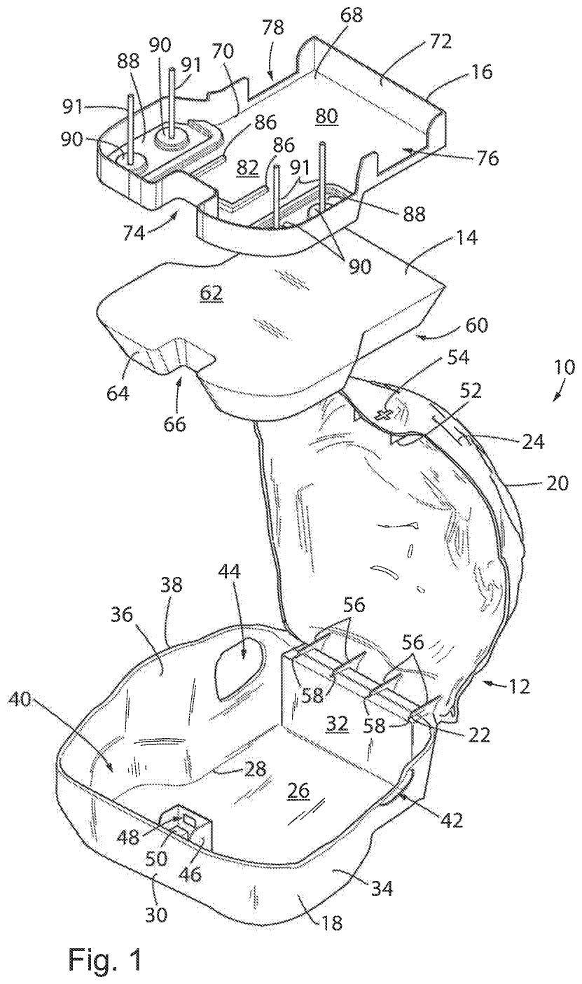

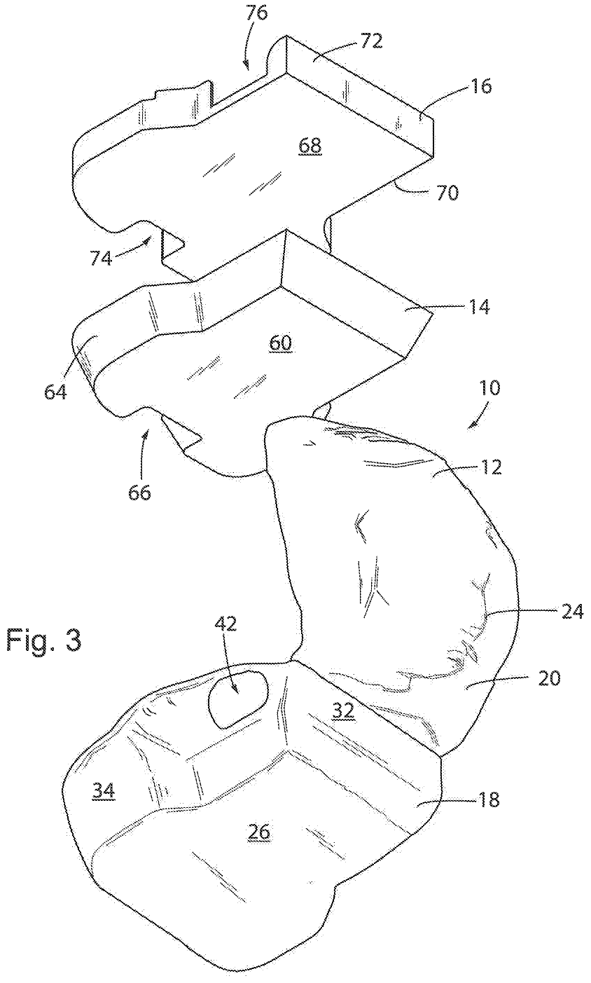

Referring initially to FIGS. 1-5 and particularly FIG. 1, there is shown a bait station 10 according to one embodiment of the present invention. The bait station 10 generally includes a housing 12, a weighted mass, i.e., a ballast 14, that is placed within the housing, and a removable tray 16 that is placed within the housing and above the ballast 14. The housing 12 consists of a base 18 and a cover 20 that is rotatable affixed to the base 18 about a hinge 22. In one embodiment of the present invention, the base 18 and cover 20 of the housing 12 are molded or thermoformed of a plastic material. As shown in FIG. 1, the housing 12, when the cover 20 is in a closed configuration, may simulate the appearance of a rock or stone through the inclusion of irregular or organic contours 24 disposed within the molding of the housing 12. As a result of the contours 24, the outer appearance of the bait station 10 is generally disguised or camouflaged, as to render its appearance less obtrusive in use. However, it should be understood that the present invention is not so limited, and that alternative outer appearances of the bait station 10 are well within the scope of the present invention, and the molded plastic construction of the housing 12 is well suited to accommodating alternative outer appearances that permit the bait station of the present invention to blend in to its surrounding. Additional features may be molded into the housing 12, such as instructions, warnings, indicia, etc.

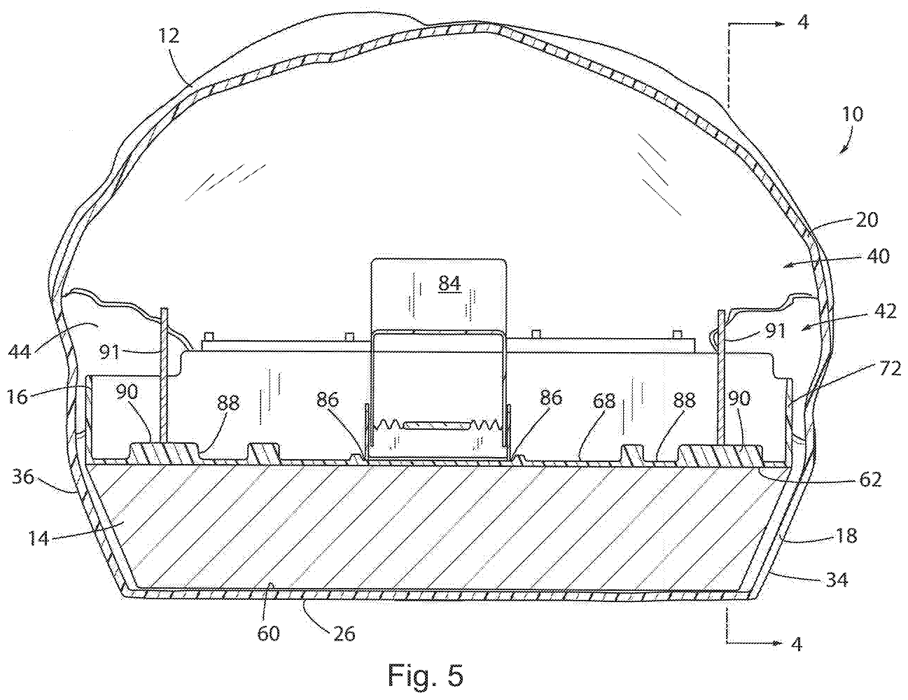

The base 18 of the housing 12 includes a bottom panel 26 that is defined within a bottom perimeter 28 and configured to be set on a support surface such as a floor or ground surface 92 as shown in FIG. 5. The base 18 also generally includes four side panels that extend upwardly from the bottom perimeter 28, including: a front panel 30, an opposing rear panel 32, a first side panel 34 extending between the front and rear panels 30, 32, and a second side panel 36 that also extends between the front and rear panels 30, 32 opposite the first side panel 34. The four side panels 30, 32, 34, 36 extend upwardly from the base perimeter 28 to an upper edge 38, which extends continuously about the top-most portion of base 18. As shown in FIG. 1, the upper edge 38 may be an irregular line. That is to say that the height of the respective four side panels 30, 32, 34, 36 may vary about the perimeter of the base 18, such that the upper edge 38 is not located at a constant distance from the base perimeter 28, but rather is variable. Preferably, the base 18 and four side panels 30, 32, 34, 36 are integrally formed together and define an interior volume 40 that is configured to receive the ballast 14 and tray 16 therein. It should be understood that while the illustrated embodiment of the bait station 10 shown in FIG. 1 includes a base 18 that has four side panels, the bait station 10 of the present invention is not so limited and any number of side panels are considered well within the scope of the present invention. That is to say that, as was previously described, in forming a bait station 10 that simulates the appearance of a rock or stone it may be desirable to form a base 18 that includes more or less than four side panels, all of which would be within the scope of the present invention.

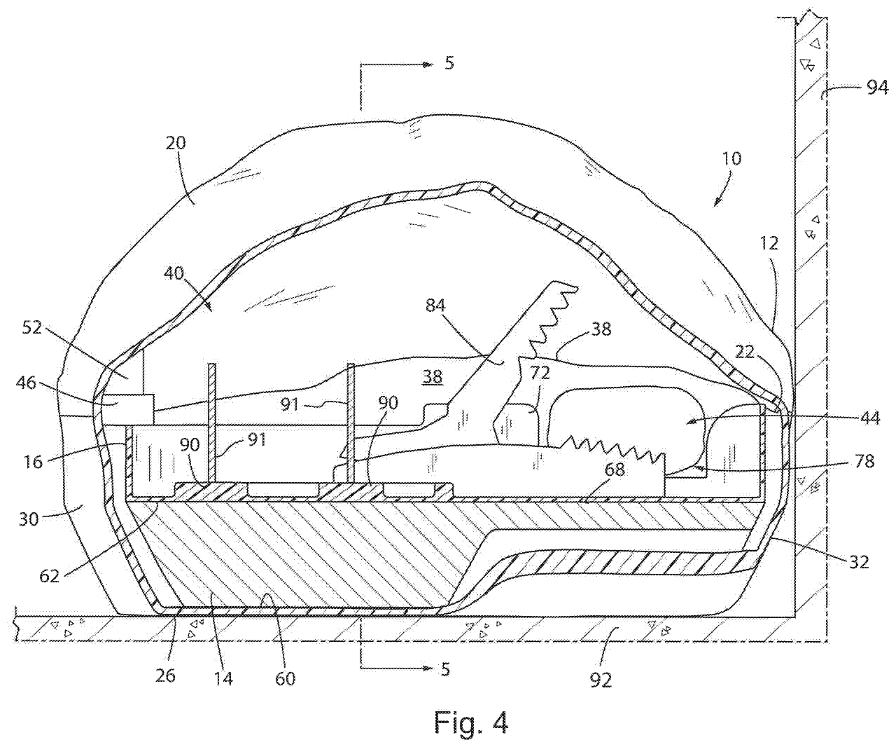

As shown in FIG. 1, the base 18 of the housing 12 includes a first rodent access opening 42 in the first side panel 34 and a second rodent access opening 44 in the second side panel 36. The access openings 42, 44 are preferably sized to allow a rodent, such as a mouse or rat, to enter into the interior volume 40 of the base 18 without restriction. As shown in FIG. 1, the access openings 42, 44 are preferably disposed at an end of the respective side panel 34, 36 that is adjacent the rear panel 32. As will be described in further detail below, such a configuration allows the bait station of the present invention to be located on a floor 92 with the rear surface 32 adjacent or abutting a wall 94, as shown in FIG. 4. As rodents traveling across a floor will typically avoid open spaces and will seek the protection provided by traversing a path located adjacent a wall, the access openings 42, 44 are preferably located proximate such a typical rodent path. This configuration increases the probability of a rodent entering into the interior volume 40 of the base 18 via one of the access openings 42, 44.

Additionally, as shown in FIG. 1, the access openings 42, 44 are positioned at a height that is raised above the bottom 26 of the base 18 and are particularly configured to open directly onto the surface of the tray 16, that rests on top of the ballast 14 within the interior volume 40 of the base 18. That is to say that a rodent entering into the bait station 10 through one of the access openings 42, 44 will climb upwardly relative to the ground or floor, through the respective access opening 42, 44 and thereby enter the interior volume 40 directly on top of the tray 16. Such a configuration, in which the rodent accesses opening 42, 44 are located at a height greater than the height of the ballast 14 is preferred to providing rodent access at or about ground level and providing an internal ramp for climbing up to the top of the ballast, as the configuration of the present invention maximizes the available internal surface area of the bottom 26 of the base 18 for receiving a larger, and thereby heavier, ballast 16. The configuration of the present invention furthermore limits the need for molding or otherwise forming intricate ramp structures in the base 18, and also inhibits entry of non-climbing animals from entering through the relatively raised access openings 42, 44.

The housing 12 preferably further includes a latch mechanism, including a lower latch frame 46 that extends within the interior volume 40 upwardly from the bottom 26 along the inner surface of the front panel 30. In one preferred embodiment, the lower latch frame 46 is disposed generally equidistance from the first and second side panels 34, 36, and includes an aperture 48 and a resilient member 50 disposed therein, which are configured to receive and engage in a locking configuration an upper latch frame member 52 when the cover 20 of the housing 12 is closed. The upper latch frame member 52, as shown in FIG. 1 extends downwardly from an inner surface of the cover 20 at a position such that it is received within and engages the lower latch frame 46 when the housing 12 is closed. As a result of pivoting the cover 20 about the hinge 22 and closing the cover 20, the lower latch frame 46 engages the upper latch frame member 52 and automatically, i.e., passively locks the bait station 10 in a closed configuration. Preferably, in order to open the bait station 10 once it has been closed, a key (not shown) is inserted through a key hole 54 located in the cover 20 adjacent the upper latch frame 52, where it engages and biases the resilient members 50 away from a neutral position, thereby disengaging the upper latch frame 52 from contacting the lower latch frame 46. It should be understood that while one embodiment of the latch mechanism has been described above and shown in FIG. 1, other securing mechanisms are well within the scope of this invention, as is relocating the position of the various components of the latch mechanism between the base 18 and cover 20 of the housing 12.

Still referring to the housing 12, a hinge 22 is preferably disposed at the upper edge 38 of the opposing rear panel 32. Alternatively, the hinge 22 may be located along the upper edge 38 of any of the side panels 30, 32, 34, 36 of the base 18. In one illustrated embodiment, the hinge 22 may include a series of arms or protrusions 56 extending downwardly from the inner surface of the cover 12, adjacent the rear surface 32, that respectively engage one or more fixation points 58, such as a bar extending along the rotational axis of the hinge 22. In this configuration the protrusions 56 and fixation points 58 may be disposed relatively inwardly of the upper edge 38 of the base 18, such that when the bait station 10 is in a closed configuration and the latch mechanism has secured the bait station 10 in a locked configuration, the hinge 22 is generally not accessible. That is to say that when the bait station 10 is closed the hinge 22 is concealed within the interior volume 40 of the bait station 10, which inhibits forcing the locked bait station open by means of bypassing the latch mechanism.

As was previously described above, the bait station 10 also includes a ballast 14, which is configured to be received within the interior volume 40 of the base 18 and rest along the inner surface of the bottom panel 26. In one embodiment of the present invention, the ballast 14, includes a bottom surface 60, a top surface 62, and a continuous side wall 64 that extends around the perimeter of the ballast 14 between the bottom surface 60 and top surface 62. The height of the ballast 14 is preferably between 0.5 inches and 2.0 inches, and more preferably between approximately 1.0 inch and 1.5 inches. As was previously described, the bait station 10 according to the present invention provides access openings 42, 44 for rodents to enter into the bait station 10. Once inside the housing 12, the rodent climbs onto the tray 16 that is resting on top of the top surface 62 of the ballast 14. As such, the height of the ballast 14 is generally selected to accommodate the climbing ability of the target animal.

As shown in FIG. 1, the size and shape of the side wall 64 is preferably substantially equal to that of the bottom perimeter 28 of the base 18, such that the ballast 14 is securely received within the base 18. However, it should be understood that a relatively smaller ballast 14 may also be received within the base 18 in accordance with the present invention.

As shown in FIG. 1, the ballast 14 may include a void or recess 66 that is generally of comparable size and shape as that of the lower latch frame 46. In use, the recess 66 will be disposed about the lower latch frame 46 as to provide increased stability and inhibit lateral movement of the ballast 14 within the volume 40. The ballast 14 is preferably formed of a dense material such as stone, concrete, brick or the like, such that the resultant ballast 14 has a weight of approximately between 2 pounds and 30 pounds, and more preferably approximately between 8 pounds and 12 pounds. In other embodiments of the present invention the ballast can be of any size or shape sufficient to fit within the housing, provide sufficient mass to resist movement and provide a support surface for rodents entering the housing. In certain particular embodiments of the present invention, the ballast can be a bladder or other receptacle having an interior cavity that can be filled with a liquid or other flowable material (e.g., pebbles). Such ballast types permit a user to provide the necessary mass at the time of or shortly before deployment of the bait station of the present invention thereby avoiding the need to ship or carry significant weight. The placement of the ballast 14 within the bait station 10 is intended to secure the base station 10 in its desired location and inhibit undesirable movement of thereof.

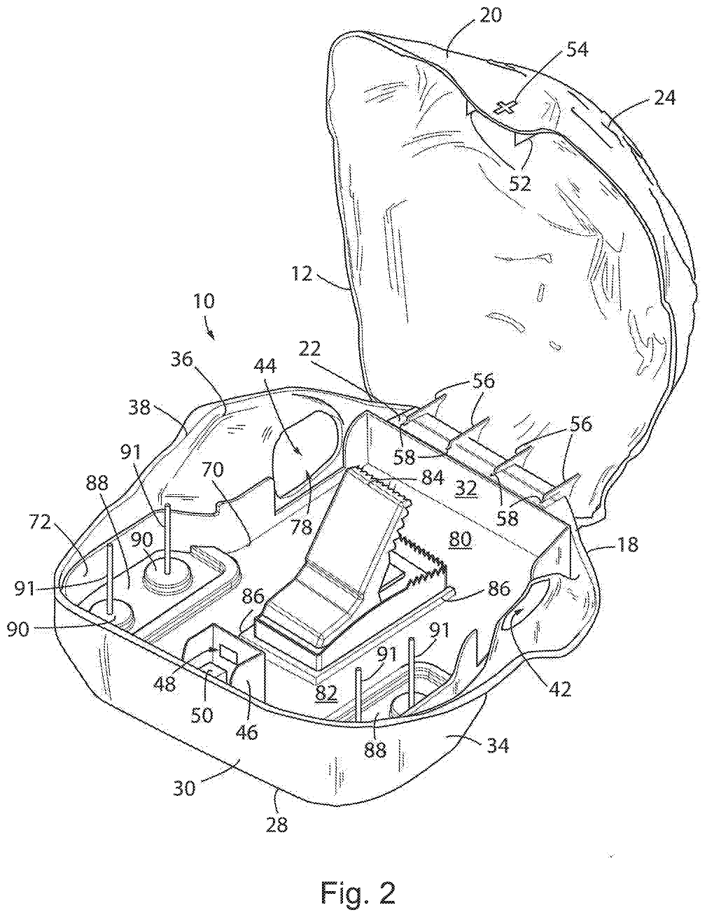

After the ballast 14 has been placed within the base 18, such the that bottom surface 60 of the ballast 14 generally rests on the inner surface of the bottom panel 26 of the base 18, a tray 16 may be positioned on top of the top surface 62 of the ballast 14. In one embodiment of the present invention, the tray 16 is molded or thermoformed of a plastic material. The tray 16 includes a bottom panel 68 that is defined within a bottom perimeter 70 that is preferably configured to be sized and shaped approximately equal to the top surface 62 of the ballast 14, upon which the tray 16 rests. A rim 72 extends upwardly from the bottom perimeter 70 about the peripheral edge of the tray 16 to a height that is less than the height of the upper edge 38 of the base 18 when the ballast 14 and tray 16 are received within the base 18. As with the ballast 14, the front end of the tray 16 may include a void or recess 74 that is generally of comparable size and shape as the lower latch frame 46. In use, the recess 74 will be disposed about the lower latch frame 46 as to provides increased stability and inhibit lateral movement of the tray 16 within the volume 40. The rim 72 of the tray 16 also includes a first reduced height portion 76 that is positioned adjacent to the first access opening 42 in the first side wall 34 of the base 18 and a second reduced height portion 78 that is positioned adjacent the second access opening 44 in the second side wall 36 of the base 18. In use, the relatively reduced height of the rim 72 at the first and second reduced height portions 76, 78 will permit a rodent to freely enter the bait station 10 via access openings 42, 44. The portion of the bottom panel 68 of the tray 16 that is located between the opposing first and second reduced height portions 76, 78 of the rib defines the rodent entry portion 80 of the tray 16, which receives the rodent as it enters into the bait station 10. The entry portion 80 of the 16 is generally located adjacent the rear panel 32 of the base 18 of the bait station 10, and generally in line with the path that the animal would be traversing as it enters the bait station 10. The portion of the bottom panel 68 of the tray 16 that is located between the entry portion 80 and the front of the recess 74 defines the central rodent trap retention area 82 that is configured to receive and secure a rodent trap 84 therein. The rodent trap 84, as shown in FIGS. 2, 4 and 5 may be a mechanical rodent trap. However, other forms of traps, for example adhesive traps, and liquid bait reserviours may also be used. The central rodent trap retention area 82 may include a series of mounting fasteners 86, such as the troughs or ridges, shown in FIG. 1, to retain the rodent trap 84 therein. Additionally, the tray 16 may include two laterally spaced apart side areas 88, that are configured to receive and retain either rodent bait blocks or rodent traps therein. Each of the side areas 88 may similarly include a series of mounting fasteners 90, such as the elevated platforms, shown in FIG. 1, each of which include an upwardly extending post 91 on which to retain the bait blocks, e.g., rodenticide bait, or receive rodent traps that are located in these areas 88.

Turning now to FIGS. 2, 4, and 5, which show the bait station 10 assembled in one embodiment including a single mechanical rodent trap 84 installed in the central rodent trap retention area 82, use of the bait station according to this embodiment of the present invention will now be described. The bait station 10 includes a housing 12 having a base 18 in which a ballast 14 is placed and a removable tray 16 is set above the ballast 14. A rodent trap 84 is placed in the central rodent trap retention area 82 of the tray 16 and loaded or armed. One or more bait blocks or alternative rodent attractant may be placed in the tray 16 as well. A cover 20 that is hingedly affixed to the base 18 is closed such that the cover 20 engages the upper edge 38 of the base 18 and is locked in a closed configuration by way of the lower latch frame member 46 engaging the upper latch frame member 52. The interior volume 40 of the base 12 is substantially sufficient to accommodate a rodent entering the bait station 10 in the closed configuration and engaging, i.e., triggering, the rodent trap 84 without interference. The bait station 10 is positioned on a floor 92 or ground and in one embodiment, as shown in FIG. 4, adjacent a wall 94 such that the access openings 42, 44 are located in the anticipated path of a target rodent. The weight of the ballast 14 inhibits movement of the bait station 10 from its desired location. The rodent, traveling across the floor 92 and adjacent the wall 94 encounters the bait station 10, and climbs upwardly through either of the respective access openings 42, 44 onto the rodent receiving area 80 of the bottom panel 68 of the tray 16. The target rodent then engages, i.e., triggers the rodent trap 84 and is trapped therein. Alternatively, the rodent can enter the trap, take some of the bait, and leave the bait station without interacting with any trap therein. A user may access the trap 84 by inserting a key into the key hole 54, which disengages the lower latch frame member 46 from the upper latch frame member 52, thereby allowing cover 20 to hingedly open. The tray 16 may then be removed from the interior volume 40 of the bait station 10, so that any trapped rodent(s) may be disposed. The bait station 10 may then be reset by replacing the tray 16 on top of the ballast 14 and/or arming the rodent trap 84 before closing the cover 20.

Although a specific embodiment is illustrated and discussed above, it is understood that the size and shape of the bait station 10 may vary greatly to accommodate space requirements and the size and shape of the rodents targeted with the respective bait station 10. While the figures have illustrated bait station 10 having a height of approximately 6.5 inches, a width of approximately 11.5 inches and a depth of approximately 9.75 inches, larger or smaller bait stations 10 are considered well within the scope of the present invention. Additionally, while the illustrated bait station 10 has a weight of approximately 9 pounds, including the ballast 14, heavier or lighter bait stations 10 are considered will within the scope of the present invention.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A bait station, comprising:
a housing having a base and a cover configured to cooperate with the base,
the base having a bottom defined within a perimeter and an at least one side panel, the side panel having a height defined between a first edge that is congruent with the perimeter of the bottom of the base and an opposing second edge,
a ballast disposed within the base,
a rodent trap retention area disposed within the housing and above a top of the ballast;
at least one rodent access opening to an interior of the housing disposed within the side panel, wherein the distance between the access opening and the first edge of the side panel is greater than a height of the ballast.

2. The bait station of claim 1, further comprising a latch having a lower latch frame extending from the base configured to engage an upper latch frame extending from the cover when the cover is in a closed configuration.

3. The bait station of claim 2, further comprising a key configured to pass through an opening in the cover to engage the latch and release the upper latch frame from engagement with the lower latch frame.

4. The bait station of claim 1, further comprising a removable tray disposed on the top of the ballast within the base.

5. The bait station of claim 4, wherein the rodent trap retention area is disposed on a top of the tray is configured to receive a rodent trap thereon.

6. The bait station of claim 5, wherein the tray comprises at least one fastener at the rodent trap retention area.

7. The bait station of claim 6, further comprising at least one rodent trap affixed to at least one rodent trap fastener.

8. The bait station of claim 5, wherein the tray further comprises an at least one bait retention area disposed adjacent the rodent trap retention area.

9. The bait station of claim 1, wherein a side of the ballast is configured to substantially engage the perimeter of the bottom of the base.

10. The bait station of claim 1, wherein the ballast defines a receptacle configured to receive a flowable material within an interior cavity of the receptacle.

11. The bait station of claim 1, wherein an outer surface of the housing comprises contours to simulate the appearance of a stone when the cover is in a closed configuration.

12. The bait station of claim 1 wherein the at least one side panel of the base further defines a front panel, a rear panel, and an opposing first and second side panels that extend from opposing ends of the front panel to the real panel respectively; and wherein the at least one access opening further defines a first access opening in the first side panel and a second access opening in the second side panel.

13. The bait station of claim 12, wherein a distance from the first access opening to the rear panel is less than a distance from first access opening to the front panel; and wherein a distance from the second access opening to the rear panel is less than a distance from second access opening to the front panel.

14. The bait station of claim 1, wherein a distance between the access opening and the second edge of the side panel is less than a distance between the access opening and the first edge of the side panel.

15. A bait station, comprising:
a housing having a base and a cover affixed to the base about a hinge,
the base having a bottom defined within a perimeter and an at least one side panel, the side panel having a height defined between a first edge that is congruent with the perimeter of the bottom of the base and an opposing second edge,
a ballast disposed within the base,
a removable tray disposed on the top of the ballast, the removable tray having a upper surface including at least one rodent trap retention area disposed therein,
at least one rodent access opening to an interior of the housing disposed within the side panel, wherein the distance between the access and the first edge of the side panel is greater than a height of the ballast.

16. The bait station of claim 15, further comprising a latch having a lower latch frame extending from the base configured to engage an upper latch frame extending from the cover when the cover is in a closed configuration.

17. The bait station of claim 16, further comprising a key configured to pass through an opening in the cover to engage the latch and release the upper latch frame from engagement with the lower latch frame.

18. The bait station of claim 15, wherein the tray comprises at least one fastener at the at least one rodent trap retention area.

19. The bait station of claim 18, further comprising at least one rodent trap affixed to the at least one rodent trap fastener.

20. The bait station of claim 15, wherein the at least one rodent access opening defines a first rodent access opening disposed on a first side of the housing and a second rodent access opening disposed on a second side of the housing, and a rodent receiving area on the upper surface of the tray between the first rodent access opening and second rodent access opening.

21. The bait station of claim 15, wherein the ballast defines a receptacle configured to receive a flowable material within an interior cavity of the receptacle.

22. A bait station, comprising:
a housing having a base and a cover affixed to the base about a hinge,
the base having a bottom defined within a perimeter, a front panel, a rear panel, and an opposing first and second side panels that extend from opposing ends of the front panel to the real panel respectively, the panels each having a height defined between a common first edge that is congruent with the perimeter of the bottom of the base and an opposing common second edge,
a ballast disposed within the base,
a removable tray disposed on a top of the ballast, the removable tray having an upper surface including at least one rodent trap retention area disposed therein,
a first rodent access opening to an interior of the housing disposed within the first side panel,
a second rodent access opening to the interior of the housing disposed within the second side panel,
wherein a distance between each rodent access opening the common first edge of the respective side panel is greater than a height of the ballast.

23. The bait station of claim 22, further comprising at least one rodent trap affixed to fastener at the at least one rodent trap retention area.
